(19) United States
(12) Patent Application Publication
(10) Pub. No.: US 2026/0312469 A1
(43) Pub. Date: Oct. 8, 2026

(54) ROTOR, SEPARATELY EXCITED SYNCHRONOUS MACHINE AND MOTOR VEHICLE

(71) Applicant: AUDI AG, Ingolstadt (DE)

(72) Inventor: Daniel RUPPERT, Lenting (DE)

(21) Appl. No.: 19/461,553

(22) Filed: Jan. 27, 2026

(30) Foreign Application Priority Data
Jan. 29, 2025 (DE) 102025103095.2

(51) Int. Cl. H02K 11/33; H02K 5/20; H02K 9/19; H02P 25/03; B60L 15/00

(52) U.S. Cl. CPC H02K 11/33; H02K 5/203; H02K 9/19; H02P 25/03; B60L 15/007; B60L 2210/30; B60L 2220/14; B60L 2240/425; H02K 2211/03

(57) ABSTRACT

A rotor for a separately excited synchronous machine. The rotor has at least one rotor winding for generating a rotor field, a secondary coil that receives inductive energy from a primary coil, and an active converter that rectifies an AC voltage induced in the secondary coil to provide a DC voltage supplied to the rotor winding. The converter is or includes a potted assembly, The potted assembly includes two half-bridges, wherein a respective half-bridge connects a respective voltage input of the potted assembly via a first switching circuit of the respective half-bridge to a first voltage output of the potted assembly and via a second switching circuit of a respective semiconductor bridge to a second voltage output of the potted assembly. The secondary coil is connected via the voltage inputs, and the rotor winding is connected via the first and second voltage outputs to the potted assembly.

### BACKGROUND

### Technical Field

The disclosure relates to a rotor for a separately excited synchronous machine having at least one rotor winding for generating a rotor field, a secondary coil which is configured to receive inductive energy from a primary coil, and an active converter which is configured to rectify an AC voltage induced in the secondary coil in order to provide a DC voltage supplied to the rotor winding. The disclosure also relates to a separately excited synchronous machine and a motor vehicle.

### Description of the Related Art

In contrast to permanently excited synchronous machines, separately excited synchronous machines do not require magnetic materials on the rotor and generate the rotor magnetic field by way of an energized winding in the rotor. This provides additional degrees of freedom in the control and design of the electrical machine. As a result, efficiency and performance increases can be achieved. The rotor winding can be energized via slip ring contacts. This is known, for example, from the publication DE 10 2022 121 516 A1.

Alternatively, energy can also be transferred to the rotor winding in a contactless manner, i.e., in particular via a converter, an inductive rotary transmitter, a rotor-side rectifier and optionally a filter for smoothing the excitation current. For efficiency reasons, active rectification using several semiconductor switches is typically advantageous here. However, cooling of the individual semiconductor switches used for rectification is complex and typically means that relatively large distances are required between the individual components of the rectifier in order to provide sufficient installation space for heat sinks. This increases the installation space requirement of the rectifier and can lead to efficiency losses due to leakage inductances.

### BRIEF SUMMARY

The disclosure is therefore based on the task of providing a rotor with an improved converter for supplying a rotor winding of the rotor.

The task is solved by a rotor of the type mentioned at the beginning, wherein the converter is or comprises a potted assembly, wherein the potted assembly comprises two half-bridges, wherein the respective half-bridge connects a respective voltage input of the potted assembly via a first switching circuit of the respective half-bridge to a first voltage output of the potted assembly and via a second switching circuit of the respective half-bridge to a second voltage output of the potted assembly, wherein the secondary coil is connected via the voltage inputs, and the rotor winding is connected via the first and second voltage outputs to the potted assembly. In one or more implementations, the potted assembly includes a complete electronic assembly covered with a potting compound, wherein the complete electronic assembly includes the two half-bridges.

It is therefore proposed in particular that the semiconductor switches used, which up to now have usually been arranged as discrete components, typically in through-hole technology, on a printed circuit board, should instead be designed as a common potted assembly. The use of the potted assembly according to the disclosure results in low material and labor costs, since the individual switching circuits do not have to be mounted separately, for example screwed to a heat sink. This also enables highly automated production and thus a further reduction in costs and an increase in robustness.

In addition, the thermal connection of the power semiconductors to a cooling system can be optimized by installing them as potted assemblies. This also results in a smaller installation space requirement. Since the use of potted assemblies, for example by optimizing the chip layout, can also minimize leakage inductances, the chip area of power semiconductors used can potentially be reduced, since the power semiconductors can be operated closer to their specification and oversizing can be avoided.

In particular, the potted assembly can comprise a semiconductor chip that forms at least the switching circuits of the half-bridges. The first and second switching circuits of the respective half-bridge can be designed as a respective semiconductor switch or, as will be explained later, preferably as a pair of semiconductor switches. In particular, the converter can be configured for bidirectional energy transmission between the primary and secondary coils.

The first and second voltage outputs of the potted assembly are preferably electrically connected to each other via a capacitor formed as part of the potted assembly. A capacitor connected between the voltage outputs of the potted assembly leads to a smoothing of the output voltage of the converter and thus to a more stable rotor field. While such a capacitor is formed separately from the semiconductor switches in conventional converters, for example as a separate capacitor, integration into the potted assembly can, on the one hand, further reduce the installation space requirement and the manufacturing costs of the rotor. On the other hand, this can further reduce leakage inductances that occur when connecting the capacitor to other components, in particular to the half-bridges, which can also further reduce losses in the converter.

The capacitor can be designed as part of a semiconductor chip, which can also include the switching circuits of the half-bridges, for example. Alternatively, however, it is also possible to design the capacitor, for example as a separately formed capacitor, separately from a semiconductor chip forming the switching circuits or the half-bridges and, for example, to encapsulate it together with such a semiconductor chip.

At least one of the voltage inputs and/or the first and/or the second voltage output can each be formed as a contact surface, which is bounded on at least two or at least three sides by a side wall projecting beyond the respective contact surface, which is formed by a potting compound and/or a housing of the potted assembly. As a result, the contact surfaces are embedded in the, in particular non-conductive, potting material or housing material or are arranged in a recessed manner therein, which means that requirements for clearance and creepage distances can be met even with small assembly sizes.

For example, the housing and/or the potting compound can form a side surface of the potted assembly that has indentations or recesses, the bottom of which is formed by the respective contact surface. In particular, it is possible for such recesses to extend to the edge of the potting compound or the housing, wherein the respective contact surface can even protrude laterally beyond the housing or the potting compound. In particular, the contact surface can be at least essentially rectangular. In addition or alternatively, the contact surface may not be bounded by one of the side walls only in a peripheral section of its circumference which is less than 50% or less than 30% of the total circumference of the respective contact surface.

The potted assembly can have control connections for the first and/or the second switching circuits of the respective half-bridge, which are each designed as a pin-shaped projection, wherein a contact section of the respective projection engages in a respective through-hole of a printed circuit board or passes through it, wherein the contact section is elastically biased by the inner surface of the through-hole, so that the respective contact section is mechanically pressed against the inner surface of the through-hole by an elastic restoring force and thereby electrically contacts a conductor of the printed circuit board which is adjacent to the through-hole and/or engages in the through-hole.

This type of connection can further reduce the manufacturing costs of the rotor, as there is no need for cable supply lines and a crimping process or the use of cable lugs, for example, and no handling of connectors and plug connections is required during manufacture. In particular, the embodiment according to the disclosure makes it possible to contact the control connections by simply plugging the printed circuit board onto the pin-shaped projections, which is easy to automate. The printed circuit board can, for example, comprise control electronics for the converter and optionally for other components of the rotor or, for example, carry a plug connector for connection to such a control unit.

The respective first and second switching circuits can each comprise a first and a second semiconductor switch, which are connected in series with one another between the respective voltage input and the respective voltage output of the potted assembly, wherein the first and second semiconductor switches each comprise an intrinsic diode and/or each are connected in parallel with a diode, wherein the diode intrinsic to the first semiconductor switch and/or connected in parallel to the first semiconductor switch has, in each case, an opposite forward direction to the diode intrinsic to the second semiconductor switch and/or connected in parallel to the second semiconductor switch.

If both semiconductor switches of a switching circuit are switched to blocking, this results in a blocking of the current flow through the switching circuit for both possible current flow directions. If both semiconductor switches are connected conductively, however, current can flow through the switching circuit for both directions of current flow, especially with low resistance. In switching states in which only one of the semiconductor switches of the respective switching circuits is switched to blocking, the diode connected in parallel with it or intrinsic to it enables a current flow through the switching circuits exclusively in the forward direction of this diode.

With this design, the converter can not only be used to receive energy for the field build-up of the rotor magnetic field via the secondary coil in the first operating mode, but it can also be used in a second operating mode to actively reduce the rotor magnetic field of the rotor winding and to radiate the energy extracted from the rotor magnetic field via the secondary coil or to transmit it to the primary coil on the stator side. On the one hand, this enables a rapid field reduction of the rotor magnetic field and thus a rapid reduction of the current flowing through the rotor winding, which can be useful in accident situations, for example, without the need for a special protective circuit on the rotor side, such as a clamping network. On the other hand, the retransmission of energy to a primary coil on the stator side enables recuperation of the energy used for the field build-up of the rotor magnetic field, which can increase the efficiency of a synchronous machine comprising this rotor.

With conventional active rectifiers for providing a current for a rotor winding, in contrast, only a single semiconductor switch with an intrinsic or parallel-connected diode is used in the respective switching circuits. When potential is applied to the rotor winding to build up or maintain the rotor magnetic field, a voltage is applied to this diode in blocking direction. However, if active field reduction is to take place in such a design in order to achieve particularly rapid field reduction and/or recuperation, the rotor winding and thus also the diode would have to be energized in the opposite direction. However, when the freewheel voltage of the diode is reached, it transports current at a low impedance, so that only very low voltages below this freewheel voltage can be used to actively reduce the current through the rotor winding when using a conventional rotor-side power converter. This problem is avoided by the use of semiconductor switches connected in series with parallel-connected or intrinsic diodes with opposite forward directions in accordance with the disclosure, since in this case, as already explained above, forwarding or freewheeling can be controlled separately for the individual current directions.

Preferably, at least one of the voltage inputs is in each case connected to the secondary coil or a respective supply line of the secondary coil by a welded connection and/or the first and/or the second voltage output are in each case connected to the rotor winding or a respective supply line of the rotor winding by a welded connection. A welded joint is mechanically very robust, conducts well, enables low leakage inductances and is easy to implement in automated production.

The rotor can comprise at least one cooling channel through which a cooling fluid can be guided in order to cool the rotor, wherein the potted assembly is attached to a side wall of the cooling channel and/or is thermally coupled to the cooling channel. Thus, the potted assembly and therefore in particular the thermally relevant switching circuits of the converter can also be cooled by rotor cooling. This means that the efficiency and service life of the converter can be further increased with little effort.

If a conductive cooling fluid is used, it may be expedient to arrange the potted assembly on the outer surface of the side wall of the cooling channel in order to prevent the cooling fluid from short-circuiting the contacts of the potted assembly. However, it is also possible for the potted assembly to be in direct contact with the cooling fluid, for example on the inside of the side wall and therefore inside the cooling channel. This is possible, for example, if an insulating cooling fluid is used and/or if contacts of the potted assembly, for example connection points with supply lines, are covered with an insulator after contacting.

The disclosure also relates to a separately excited synchronous machine having a stator comprising a primary coil and an energizing device which is configured to supply the primary coil with an alternating current, wherein the separately excited synchronous machine comprises a rotor according to the disclosure.

The energizing device can in particular be a converter which is supplied by a DC voltage source, for example a battery, which can in particular be arranged outside the synchronous machine, for example in a motor vehicle comprising the synchronous machine. In particular, the energizing device can be designed as a further potted assembly and/or arranged in or on the stator.

The energizing device can comprise at least two energizing device half-bridges, wherein the respective energizing device half-bridge connects a respective energizing device output to a first energizing device input via a first switching device of the respective energizing device half-bridge and to a second energizing device input via a second switching device of the respective energizing device half-bridge. Preferably, a switching circuit section of the energizing device is connected to the first energizing device input via a first capacitor and to the second energizing device input via a second capacitor, wherein the energizing device comprises a further switching device via which the switching circuit section is connected to a first one of the energizing device outputs. If the energizing device is designed as a potted assembly, it can preferably also comprise the capacitors.

If a predetermined voltage is applied to such an energizing device between the two energizing device inputs during operation, an intermediate voltage is established in the switching circuit section due to the capacitors, which corresponds to half the voltage drop between the energizing device inputs, for example, when using the same capacitors of the capacitors.

If the further switching device is switched to blocking, the converter can be operated in a first operating mode in the usual way as a full-bridge converter. If, on the other hand, the further switching device is switched to conductive in a second operating mode while the switching devices of the energizing device half-bridge assigned to the first energizing device output are switched to blocking, the first energizing device output is permanently at least approximately at the intermediate voltage. The remaining second energizing device output can then be switched between the voltages applied to the voltage inputs by the operation of the remaining energizing device half-bridge, in particular periodically. This reduces the amplitude of the output voltage compared to the first operating mode described above.

Compared to reducing the AC voltage amplitude by reducing the pulse width of the converter, switching to the second operating mode has the advantage that the voltage jump or voltage gradient for the voltage dropping between the voltage outputs when switching the remaining energizing device half-bridge in the second operating mode is smaller than the voltage jump or voltage gradient when switching the full bridge in the first operating mode. This can reduce losses that occur when filtering this voltage drop or due to harmonic components of the voltage drop. In operating ranges in which the voltage amplitude of this voltage drop achievable in the second operating mode is sufficient to energize the primary coil, the efficiency of the synchronous machine according to the disclosure can thus be further increased.

The disclosure also relates to a motor vehicle that comprises a separately excited synchronous machine according to the disclosure. In particular, the separately excited synchronous machine can be used as the motor vehicle’s drive engine. Since particularly high power densities are to be achieved in motor vehicle drive engines, the advantages achieved by the design of the separately excited synchronous machine or its rotor in accordance with the disclosure are particularly relevant.

### BRIEF DESCRIPTION OF THE SEVERAL VIEWS OF THE DRAWINGS

Further advantages and details of the disclosure result from the following exemplary embodiments as well as from the figures. The figures show schematically:

FIG. 1 is an exemplary embodiment of a separately excited synchronous machine according to the disclosure, which comprises an exemplary embodiment of a rotor according to the disclosure,

FIG. 2 is an embodiment example of a potted component used as a converter in FIG. 1, and

FIG. 3 is a detailed view of the potted component shown in FIG. 2 in an installation position.

### DETAILED DESCRIPTION

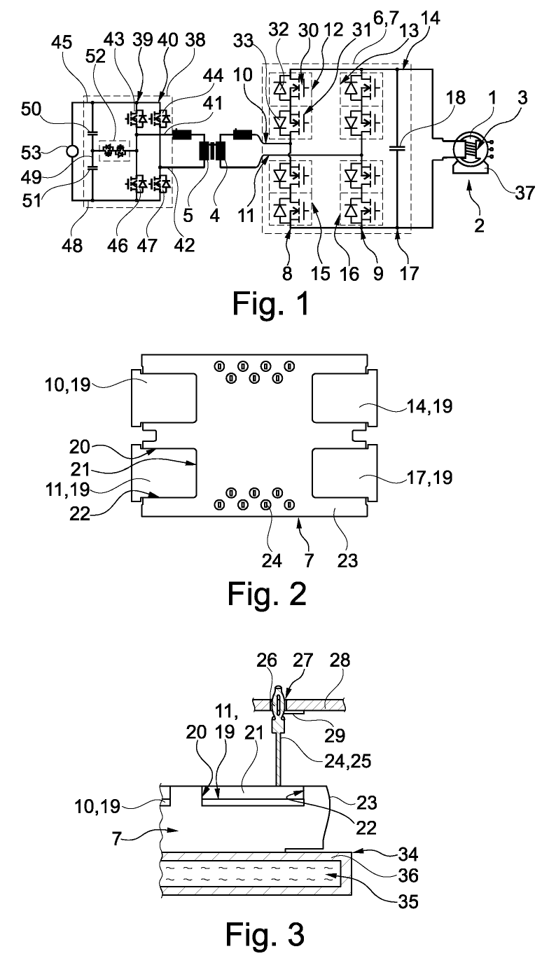

FIG. 1 schematically shows a separately excited synchronous machine 2 including an excitation circuit which serves to energize a rotor winding 3 of the rotor 1 of the separately excited synchronous machine 2 and which in the example comprises components for inductive energy transmission, namely in the example a stator-side primary coil 5 with associated energizing device 38 and a rotor-side secondary coil 4 with downstream active converter 6. The converter 6 is used to rectify an AC voltage induced in the secondary coil 4 during operation of the primary coil 5, resulting in a DC voltage supplied to the rotor winding 3.

The separately excited synchronous machine 2 can, for example, be the drive motor of a motor vehicle not shown, which is usually coupled to the wheels of at least one axle of the motor vehicle in order to drive them.

Since the design of the active converter 6 and the energizing device 38 are primarily relevant for the following explanations, the separately excited synchronous machine 4 itself is only shown very abstractly on the right in the figure, wherein the components mentioned, which, as will be explained in more detail below, are arranged partly in the rotor 1 and partly in the stator 37 in the synchronous machine 2, are shown enlarged in the form of a circuit diagram.

To energize the rotor winding 3, energy is to be transmitted from a fixed DC voltage source 53, for example the vehicle electrical system of a motor vehicle, to the rotating coordinate system of the rotor 1. In the synchronous machine 2 shown, this is achieved by the DC voltage provided by the DC voltage source 53 being converted by the stator-side energizing device 38 in order to apply AC voltage to the stator-side primary coil 5. The resulting alternating field induces an AC voltage in the rotor-side secondary coil 4, which is rectified by the rotor-side converter 6 to provide a direct current for the rotor winding 3. The converter 6 acts as an active rectifier.

In order to achieve high installation space efficiency, low leakage inductance and manufacture of the rotor 1 with little effort, the converter 6 is designed as a potted assembly 7. The potted assembly 7 comprises two half-bridges 8, 9. The respective half-bridge 8, 9 connects a respective voltage input 10, 11 of the potted assembly 7 via a respective first switching circuit 12, 13 to a first voltage output 14 of the potted assembly 7. Accordingly, the respective voltage input 10, 11 of the potted assembly is connected to a second voltage output 17 of the potted assembly 7 via a respective second switching circuit 15, 16.

In the example, second semiconductor switches 30, 31 are used for the respective first and second switching circuits 12, 13, 15, 16, which are connected in series in such a way that their intrinsic or parallel-connected diodes 32, 33 have forward directions that are opposite to each other. As already explained in the general section, for an exclusive use of the converter 6 to build up or maintain the rotor field, it would be sufficient to use a single semiconductor switch 30, 31 for the respective switching circuits 12, 13, 15, 16. However, by using two semiconductor switches 30, 31 with diodes 32, 33 connected in opposite directions, a counter voltage can also be generated to reduce the rotor field, for example to quickly achieve a de-energized state of the rotor winding 3 in the event of an accident or to recuperate the field energy.

A capacitor 18 is connected between the voltage outputs 14, 17 to stabilize the output voltage of the converter 6. By integrating this capacitor 18 into the potted assembly 7, the leakage inductance between the semiconductor bridges 8, 9 and the capacitor 18 can be minimized, thus avoiding efficiency losses.

As depicted in FIG. 2 and 3, the voltage inputs 10, 11 and the voltage outputs 14, 17 of the potted assembly 7 are each designed as a contact surface 19. This allows the secondary coil 4 and the rotor winding 3 or supply lines to these components to be connected to the potted assembly 7 and thus to the converter 6 easily, even in an automated manufacturing process, and with a large contact surface, for example by welding.

Particularly in the field of power electronics, for example when the synchronous machine 2 is used as a drive engine for a motor vehicle, high requirements on clearance and creepage distances can result. In order to be able to comply with said requirements even with a small size of the potted assembly 7, the power-carrying connections, i.e., the voltage inputs 10, 11 and the voltage outputs 14, 17, are set back slightly in the example with respect to the surface of the housing 23 facing the observer in FIG. 2, so that the respective contact surface 19 is limited on three sides by a side wall 21 to 23 projecting beyond the respective contact surface 19. This is particularly clearly visible in FIG. 3.

The control connections 24 used to control the switching circuits 12, 13, 15, 16, on the other hand, carry low voltages and currents and can therefore be arranged at a relatively small distance from each other. For simple, in particular automated, manufacture of the rotor 1, it is useful if a control unit can be attached to the potted assembly 7 and electrically connected to it by a simple movement during manufacture.

Therefore, as can be clearly seen in FIG. 3, the control connections 24 in the example are each designed as a pin-shaped projection 25, which can be compressed in a contact section 26 in order to make mechanical and, in particular, electrical contact with the inner surface of the through-hole 27 of a printed circuit board 28 when it is received in a through-hole 27. In the finished rotor 1, the respective contact section 26 is thus mechanically pressed against the inner surface of the through-hole 27 by an elastic restoring force, whereby a conductor 29 of the printed circuit board 28 adjacent to the through-hole 27 and/or engaging in the through-hole is electrically contacted.

By designing the converter 6 or at least a large part of its components as a potted assembly 7, the converter 6 or, in particular, its semiconductor switches can also be cooled with little effort. In particular, as depicted in FIG. 3, a cooling channel 34 can be used for this purpose, which guides a cooling fluid 35 to cool the rotor 1 during operation of the synchronous machine 2. In order to use the cooling channel 34 to cool the potted assembly 7, the assembly 7 can, as depicted in FIG. 3, be attached to a side wall 36 of the cooling channel 34, for example by being screwed or glued to it.

In the example, the energizing device 38 is largely constructed like a conventional converter and thus comprises two energizing device half-bridges 39, 40, which each connect a respective energizing device output 41, 42 to a first energizing device input 45 via a respective first switching device 43, 44 and to a second energizing device input 48 via a respective second switching device 46, 47.

However, in order to further improve the efficiency of the separately excited synchronous machine, the energizing device 38 additionally comprises a switching circuit section 49, which is connected on the one hand via a respective capacitor 50, 51 to the first and second energizing device input 45, 48 and on the other hand via a further switching device 52, which in the example is formed by two semiconductor switches with intrinsic diodes directed in opposite directions to one another, to the energizing device output 41.

As already explained in detail in the general section, the energizing device 38 can function as a conventional full-bridge converter when the further switching device 52 is closed. By opening the further switching device 52 when the switching devices 43, 46 of the energizing device half-bridge 39 are continuously closed, the energizing device can be operated as a half-bridge converter. This reduces the amplitude of the AC voltage between the energizing device outputs 41, 42 on the one hand, and the magnitude of the voltage jump of this voltage when switching the remaining energizing device half-bridge 40 on the other hand, compared to operation as a full-bridge converter. Compared to an amplitude reduction due to smaller pulse widths when operating as a full-bridge converter, a gain in efficiency can be achieved by reducing this voltage jump, as already explained in the general part of the description.

German patent application no. 102025103095.2, filed Jan. 29, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A rotor of a separately excited synchronous machine, the rotor comprising:
at least one rotor winding that, in operation, generates a rotor field;
a secondary coil that, in operation, receives inductive energy from a primary coil; and
an active converter that, in operation, rectifies an alternating current (AC) voltage induced in the secondary coil and provides a direct current (DC) voltage supplied to the rotor winding,
wherein the active converter includes a potted assembly,
wherein the potted assembly includes a first half-bridge and a second half-bridge,
wherein the first half-bridge connects a first voltage input of the potted assembly via a first switching circuit of the first half-bridge to a first voltage output of the potted assembly,
wherein the second half-bridge connects a second voltage input of the potted assembly via a second switching circuit of the second half-bridge to a second voltage output of the potted assembly,
wherein the secondary coil is connected to the potted assembly via the first voltage input and the second voltage input, and
wherein the rotor winding is connected to the potted assembly via the first and second voltage outputs.

2. The rotor according to claim 1, wherein
the first voltage output and the second voltage output of the potted assembly are electrically connected to one another via a capacitor formed as part of the potted assembly.

3. The rotor according to claim 1, wherein
at least one of the first voltage input, the second voltage input, the first voltage output, or the second voltage output is formed as a contact surface that is bounded on at least two sides by a side wall that projects beyond the contact surface and is formed by a potting compound and/or a housing of the potted assembly.

4. The rotor according to claim 3, wherein
the at least one of the first voltage input, the second voltage input, the first voltage output, or the second voltage output that is formed as the contact surface is bounded on at least three sides by the side wall that projects beyond the contact surface.

5. The rotor according to claim 1, wherein
the potted assembly has control connections for the first switching circuit of the first half-bridge and/or the second switching circuit of the second half-bridge,
each of the control connections is a pin-shaped projection and has a contact section that engages or passes through one of a plurality of through-holes of a printed circuit board, and
each contact section is elastically biased by an inner surface of one of the through-holes, such that each contact section is mechanically pressed against the inner surface of the one of the through-holes by an elastic restoring force and electrically contacts a conductor of the printed circuit board that is adjacent to one of the through-holes and/or engages in the one of the through-holes.

6. The rotor according to claim 1, wherein
the first switching circuit includes a first semiconductor switch and a second semiconductor switch that are connected in series with one another between the first voltage input and the first voltage output of the potted assembly,
the second switching circuit includes a third semiconductor switch and a fourth semiconductor switch that are connected in series with one another between the second voltage input and the second voltage output of the potted assembly
each of the first semiconductor switch, the second semiconductor switch, the third semiconductor switch, and the fourth semiconductor switch includes an intrinsic diode and/or is connected in parallel with a diode, and
the intrinsic diode of the first semiconductor switch and/or the diode connected in parallel with the first semiconductor switch has an opposite forward direction to the intrinsic diode of the second semiconductor switch and/or the diode connected in parallel with the second semiconductor switch.

7. The rotor according to claim 1, wherein
at least one of the first voltage input or the second voltage input is connected to the secondary coil or a supply line of the secondary coil by a welded connection and/or the first voltage output and/or the second voltage output are connected to the rotor winding or a supply line of the rotor winding by a welded connection.

8. The rotor according to claim 1, further comprising:
at least one cooling channel through which a cooling fluid, in operation, is guided in order to cool the rotor, wherein the potted assembly is attached to a side wall of the at least one cooling channel and/or is thermally coupled to the cooling channel.

9. A separately excited synchronous machine comprising:
a stator that includes a primary coil and an energizing device that, in operation, supplies an alternating current to the primary coil; and
the rotor according to claim 1.

10. The separately excited synchronous machine according to claim 8, wherein
the energizing device includes at least a first energizing device half-bridge and a second energizing device half-bridge,
the first energizing device half-bridge connects a first energizing device output via a first switching device of the first energizing device half-bridge to a first energizing device input,
the second energizing device half-bridge connects a second energizing device output via a second switching device of the second energizing device half-bridge to a second energizing device input,
a third switching circuit of the energizing device is connected to the first energizing device input via a first capacitor and to the second energizing device input via a second capacitor, and
the energizing device includes a third switching device via which the third switching circuit is connected to one of the first energizing device output and the second energizing device output.

11. A motor vehicle, comprising:
the separately excited synchronous machine according to claim 9.
